(19) United States
(12) Patent Application Publication
(10) Pub. No.: US 2006/0064303 A1
(43) Pub. Date: Mar. 23, 2006

(54) Method and apparatus for programming a portable device

(76) Inventor: Dieter Georg Seiler, Carleton Place (CA)

Correspondence Address: Gowling Lafleur Henderson LLP, 2600-160 Elgin Street, Ottawa, K1P 1C3, CA

(21) Appl. No.: 11/227,172

(22) Filed: Sep. 16, 2005

Related U.S. Application Data
(60) Provisional application No. 60/610,535, filed on Sep. 17, 2004.

(51) Int. Cl. G10L 21/06

(52) U.S. Cl. 704/276

(57) ABSTRACT

A method of and apparatus for programming a screen of a portable device is provided. The method includes the steps of providing a sound file encoded with screen information for programming a display of a portable device, playing the sound file to send an audio signal to the portable device via an audio channel, at the portable device, decoding the audio signal to receive the screen information, and generating a screen in dependence upon the screen information received. The sound file conveniently takes the form of a RIFF file and in a particular example a WAV file format. The embodiments of the present invention allow transfer of information by “playing” of the sound file to a portable device via a physical link.

This non-provisional application claims benefit of U.S. Provisional Application No. 60/610,535 filed on Sep. 17, 2004.

### FIELD OF THE INVENTION

The present invention relates to methods and apparatuses for programming a portable device and is particularly concerned with using a variety of existing hardware and software to advantage.

### BACKGROUND OF THE INVENTION

There are many well established physical interfaces and data protocols for transferring data between sending devices and receiving devices. Well known interfaces such as RS-232 have been known for decades and have been replaced with higher speed interfaces such as USB and Firewire. However, these improvements have been the result of concerns with increased transfer speed, and lower bit error rates (BER). Little or no consideration is given to seeking cost effective alternatives to standard physical interfaces. As a consequence small portable devices, such as personal data assistants (PDAs), are provided with cradles, often housing proprietary connectors, in order to interface with personal computers. Such solutions, while effective, increase the cost of the portable device, while limiting it to a single host device (without the additional expense of further cradles).

This type of solution is acceptable for high end devices such as PDAs, but would not be acceptable for certain individual consumer devices, in particular devices having only a limited need for data transfer. Consequently, there is a need in the prior art for a cost effective data transfer method and apparatus for portable devices.

### SUMMARY OF THE INVENTION

An object of the present invention is to provide an improved method and apparatus for programming a portable device.

In accordance with an aspect of the present invention there is provided a method of programming a screen of a portable device comprising the steps of: providing a sound file encoded with screen information for programming a display of a portable device; playing the sound file to send an audio signal to the portable device via an audio channel; at the portable device, decoding the audio signal to receive the screen information; and generating a screen in dependence upon the screen information received.

In accordance with another aspect of the present invention there is provided an apparatus for programming a screen of a portable device comprising: means for providing a sound file encoded with screen information for programming a display of a portable device, means for playing the sound file to send an audio signal to the portable device via an audio channel, and a portable device including a decoder for the audio signal to receive the screen information and a display driver for generating a screen in dependence upon the screen information received.

Preferably, the sound file is a WAV (.wav) format file.

### BRIEF DESCRIPTION OF THE DRAWINGS

The present invention will be further understood from the following detailed description with reference to the drawings in which:

FIG. 1 illustrates an apparatus for programming a portable device in accordance with an embodiment of the present invention;

FIG. 2a and 2b graphically illustrate an example of a waveform used by the apparatus of FIG. 1;

FIG. 3 illustrates in a flow diagram a method of the apparatus of FIG. 1 in accordance with an embodiment of the present invention; and

FIG. 4a and 4b show two examples of how the portable device may be programmed in a remote environment using existing audio playback devices.

### DETAILED DESCRIPTION OF THE PREFERRED EMBODIMENTS

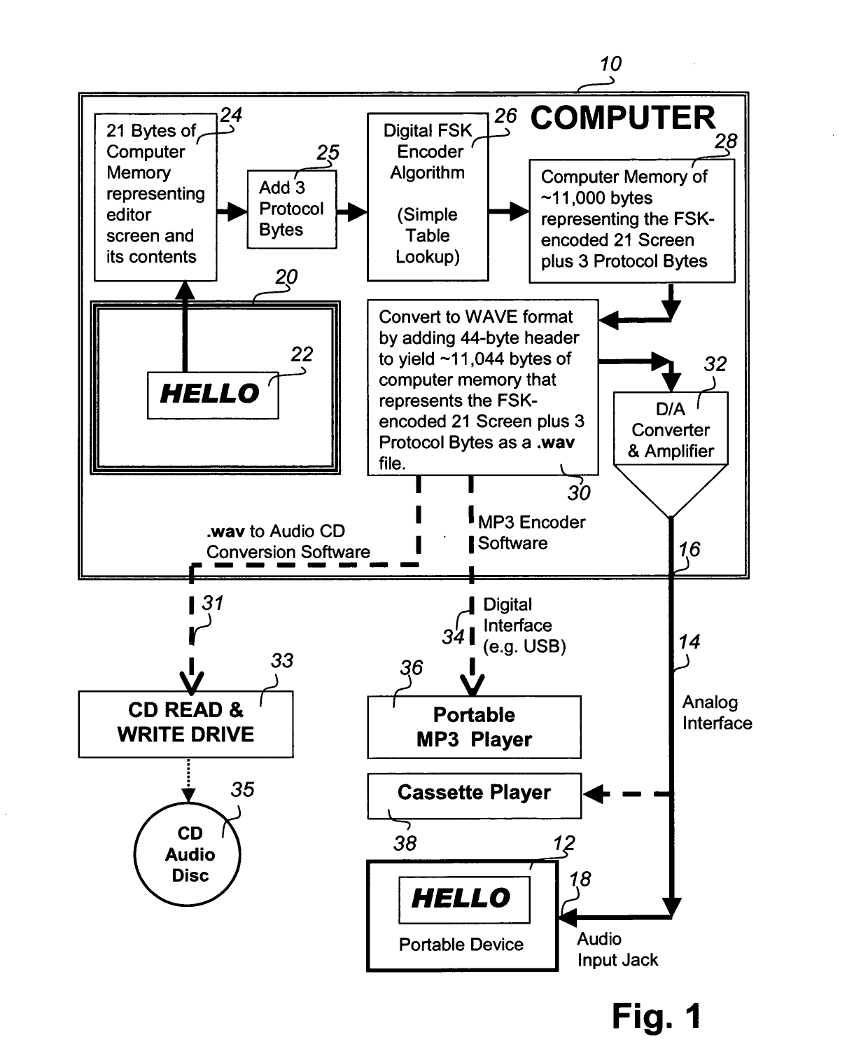

Referring to FIG. 1 there is illustrated an apparatus for programming a portable device in accordance with an embodiment of the present invention. The apparatus of FIG. 1 includes a computer 10, a portable device 12 to be programmed and a physical connection 14. In order to provide a cost effective physical transfer medium, the physical connection 14 uses the audio output 16 of computer 10 and an audio input jack 18 of portable device 12.

The computer 10 includes a computer screen 20 and a screen editor 22. The screen editor 22 is used by the computer operator to create or edit screens for the portable device, which may be text strings or bit-mapped graphics to be programmed into the portable device 12. Once the screen has been created, for example the text string “HELLO”, the user initiates the portable device 12 programming or “download” process. This process begins with the computer saving the entire dot matrix editor screen, which includes the text string, to a memory block 24. The memory requirement for the dot matrix screen is 168 bits (21 bytes) for a 168-LED screen on the portable device 12. Three typical protocol bytes consisting of a synchronization byte, a control byte, and a checksum byte, are then added 25 to the existing dot matrix screen data to yield a total of 24 bytes. The protocol bytes are used later by the portable device 12 to ensure accurate reception and decoding of the dot matrix screen data. A digital FSK encoder algorithm 26, for example in the form of a lookup table, is then applied to the stored data to generate a digitally FSK-encoded dot matrix screen. Using a self-clocking FSK scheme with a 11,025 Hz sampling bit rate, approximately 11,000 bytes of information 28 are required to represent the 24 bytes for the dot matrix screen and protocol. A very inefficient coding scheme from a memory utilization sense. However, this information 28 can be converted 30 to a WAV file by adding a 44-byte header. WAV files are a special Microsoft Windows format that contain the Windows PCM (pulse code modulated) waveform data, which is pure, uncompressed pulse code modulation-formatted data. Once in a WAV file format, the file can be played on the computer 10 to produce an analog audio signal via a digital to analog converter 32 and audio output port 16 to effect transfer of the information to the portable device 12 via the physical cable connection 14 and audio input jack 18. The portable device includes an FSK decoder to convert the analog audio signal back into a 21 byte dot matrix screen used directly to control the LED display in dot matrix fashion.

Alternatively, ASCII codes could be used for text only screens. IN this case only 5 bytes instead of the former 21 bytes would be needed to encode an editor screen with the text “HELLO”. The portable device would include a character generator lookup table to convert the decoded ASCII codes into characters displayable on the dot matrix LED display.

Advantageously, no additional hardware is needed to effect transfer of the information as the computer's existing audio capability is used. As a further advantage, the WAV format files may be stored for later use. These same files can also be converted and transferred in digital form 31 to storage devices such as a CD audio disc 35 via CD ROM burner 33, or compressed using MPEG3 encoder software and stored via a digital interface 34 such as USB (universal serial bus) in an MP3 Player 36, for later transfer to the portable device 12. Similarly, analog-input devices 38 such as cassette tape recorders or DAT (digital audio tape) recorders can be used to record the audio output from the computer 10, and then played back to the audio input 18 of the portable device 12.

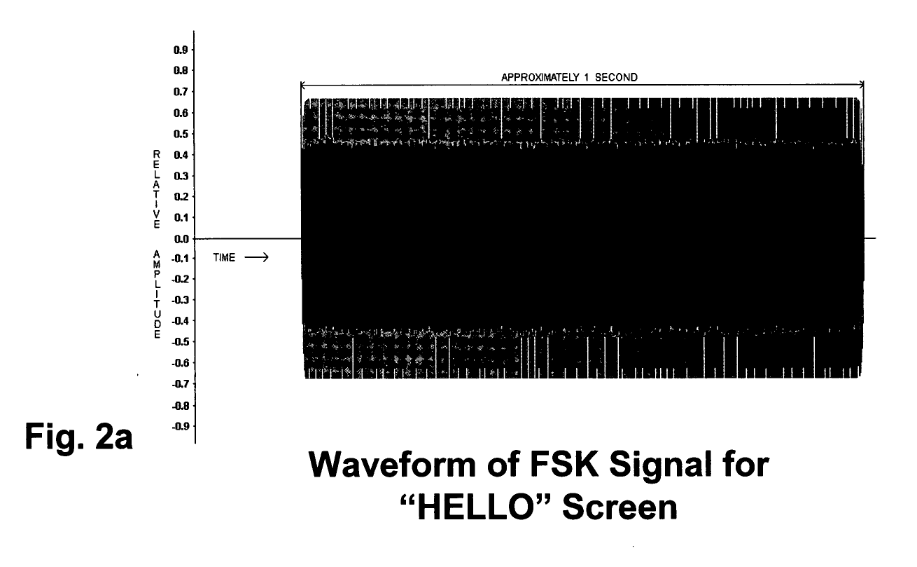

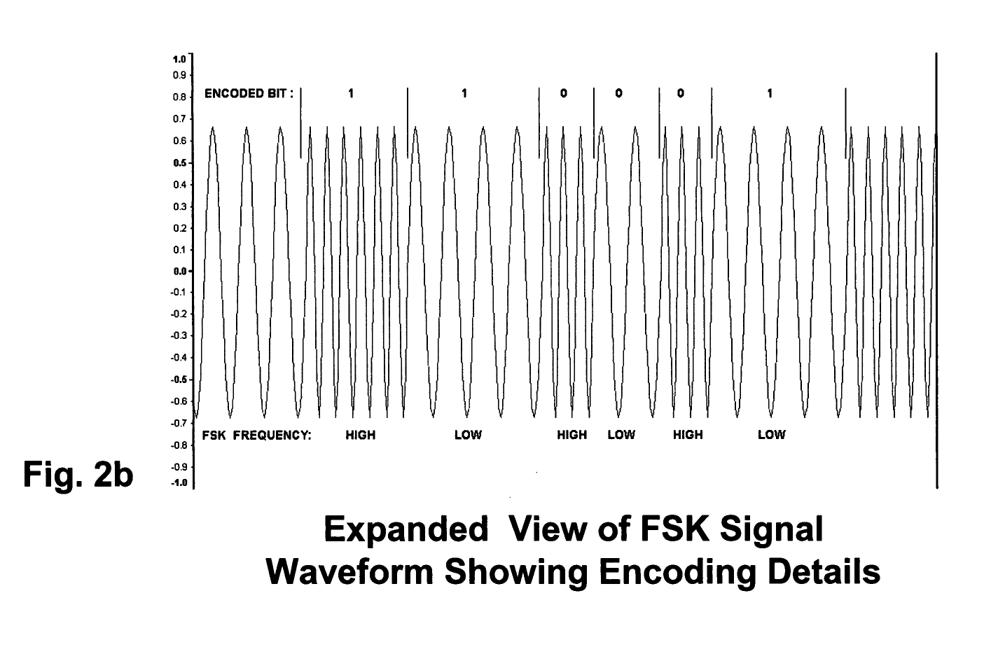

Referring to FIGS. 2a and 2b there is graphically illustrated an example of a waveform used by the apparatus of FIG. 1. The waveform shown in FIG. 2a is the analog FSK audio signal that is sent via the audio cable physical connection 14 to the portable device 12, and represents the dot matrix screen text “HELLO”. A section of this waveform is shown in detail in FIG. 2b where the FSK encoding scheme used in the present embodiment is illustrated.

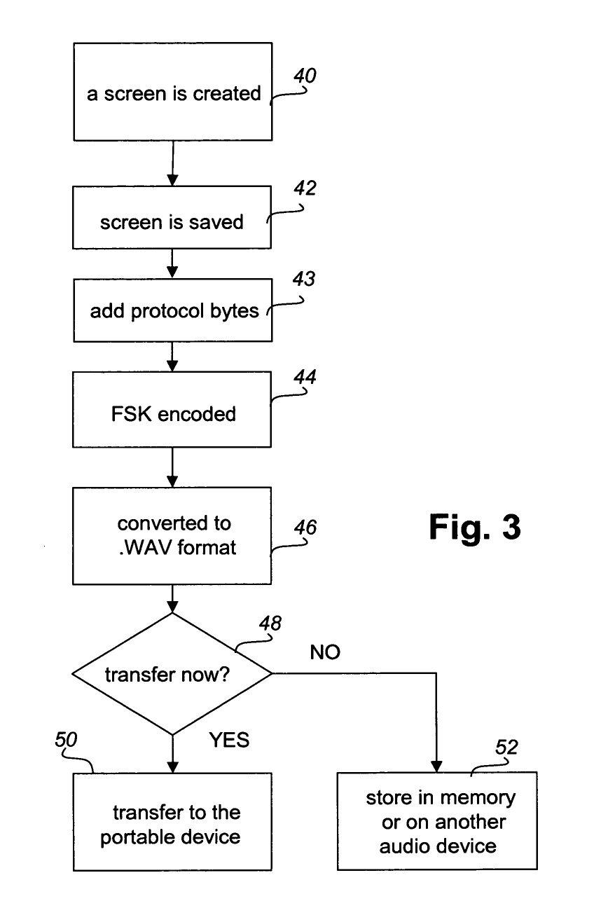

Referring to FIG. 3 there is illustrated in a flow diagram a method of the apparatus of FIG. 1 in accordance with an embodiment of the present invention. The method of FIG. 3 begins when a screen is created 40. The screen is then saved 42 to memory as 21 bytes. Three typical protocol bytes are added 43 to the 21 bytes. The resulting 24 bytes are digitally FSK-encoded 44 to generate about 11,000 bytes. The encoded information is then converted 46 to a WAV format file by adding a 44-byte header. The decision block 48 represents an operator deciding to immediately effect transfer 50 to the portable device or electing to store the WAV file in digital form or analog form 52 to memory or another audio device for transfer at a later date.

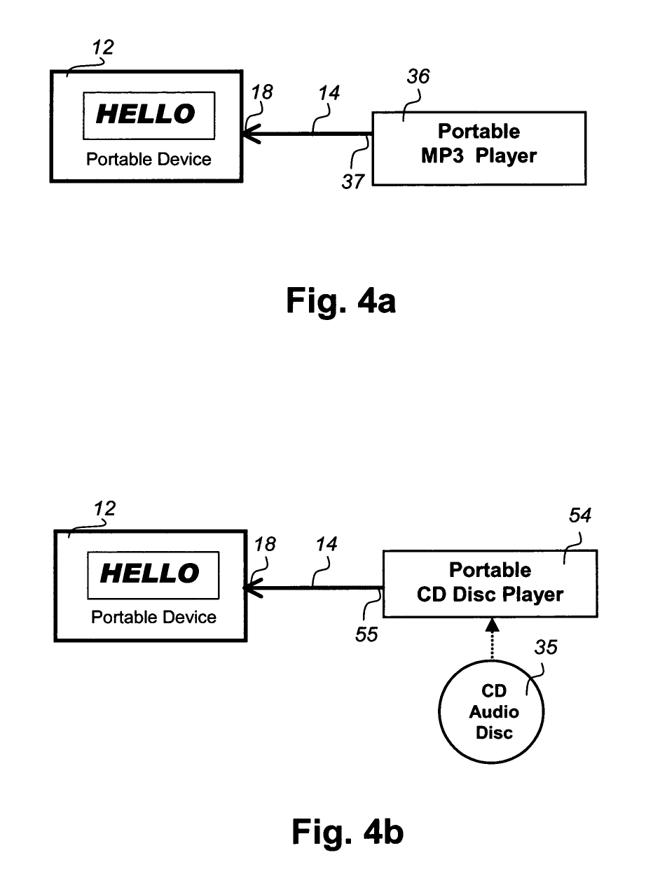

While the figures show using a computer as an apparatus for creating screens, embodiments of the present invention include using the computer as a client for either downloading or reading pre-existing WAV files for programming the portable device 12. For example, the computer 10 may include a web browser for accessing WAV files from a web site. An illustration of how existing portable audio devices may be used in a remote environment to program the portable device 12 is shown in FIG. 4. The example in FIG. 4a shows a portable MP3 Player 36 that has previously been programmed with the MP3-encoded version of the FSK WAV file 30, interfaced to the audio input jack 18 of the portable device 12 via the audio cable connection 14 to the output audio jack 37 of the MP3 Player. The portable device 12 is turned on in “download” mode, and the appropriate “HELLO” track on the MP3 Player 36 is selected for playback, and in approximately one second the “HELLO” dot matrix screen data is programmed into the portable device. Similarly in FIG. 4b a CD disk 35 that has the previously recorded dot matrix screen data in audio CD format, is played back by means of a portable CD Disc Player 54. The audio output jack 55 of the CD Disc Player 54 is connected to the input audio jack 18 of the portable display 12 by means of the audio cable 14. The programming procedure for the portable device using the CD Player is similar to that described earlier for the MP3 Player.

Although the storage of the dot matrix display data requires several or even tens of kilobytes as an FSK-encoded audio file (depending on the type of compression used, if any), the extremely large amounts of memory capacity on typical audio storage and playback devices would allow for the storage and retrieval of hundreds or even thousands of different dot matrix display screens on a single MP3 Player or CD disc. The embodiment of this invention is not limited to dot matrix LED screens, but is equally applicable to other forms of display screens typically found in the industry, such as 7-segment, vacuum fluorescent, LCD, or plasma display technologies.

While FSK encoding has been used in the above described embodiment of the present invention, as would be clear to those of ordinary skill in the art, other coding schemes could be used, for example burst tone modulation (BTM) or pulse width carrier modulation (PWCM). Similarly, WAV format sound files have been used in the above embodiment, however suitable other audio or multimedia file formats can be used to produce an analog audio output.

While the audio channel has been described as a physical link in the above described embodiment the audio channel may include a link selected from the following: a physical link; a radio frequency (RF) link, an infrared (IR) link, an acoustic link, and an optical link.

Numerous modifications, variations and adaptations may be made to the particular embodiments described herein above without departing from the scope of the present invention as defined in the claims.

What is claimed is:

1. A method of programming a screen of a portable device comprising the steps of:
providing a sound file encoded with screen information for programming a display of a portable device;
playing the sound file to send an audio signal to the portable device via an audio channel;
at the portable device, decoding the audio signal to receive the screen information; and
generating a screen in dependence upon the screen information received.

2. A method as claimed in claim 1 wherein the step of providing a sound file comprises the step of accessing the sound file.

3. A method as claimed in claim 2 wherein the step of accessing the sound file includes accessing a file saved on any one of a hard drive, a data DVD disc, a USB memory stick, a DAT tape, an Audio CD, a RAM memory or a semiconductor memory.

4. A method as claimed in claim 1 wherein the step of providing a sound file comprises the step of downloading the sound file.

5. A method as claimed in claim 4 wherein the step of downloading the sound file includes the step of downloading to one of a personal computer, a personal data assistant (PDA), a telephone, a cellular telephone, and a wireless telephone.

6. A method as claimed in claim 4 wherein the step of downloading the sound file includes the step of downloading to a CD writer.

7. A method as claimed in claim 4 wherein the step of downloading the sound file includes the step of downloading to an MP3 player.

8. A method as claimed in claim 2 wherein the sound file includes one of the following formats: waveform data (.WAV), audio/visual interleaved data (.AVI), MIDI information (.RMI), multimedia movie (.RMN), a bundle of RIFF files (.BND), and an MP3 file.

9. A method as claimed in claim 1 wherein the audio channel includes at least one of an analog output, or a digital input.

10. A method as claimed in claim 1 wherein the audio channel includes a link selected from the following a physical link, a radio frequency (RF) link, an infrared (IR) link, an acoustic link, and an optical link.

11. Apparatus for programming a screen of a portable device comprising:
means for providing a sound file encoded with screen information for programming a display of a portable device;
means for playing the sound file to send an audio signal to the portable device via an audio channel; and
a portable device including a decoder for the audio signal to receive the screen information and a display driver for generating a screen in dependence upon the screen information received.

12. Apparatus as claimed in claim 11 wherein the means for providing a sound file comprises means for accessing the sound file.

13. Apparatus as claimed in claim 11 wherein the means for accessing includes anyone of a hard drive, a CD Rom, a diskette, a data DVD disc, a USB memory stick, an audio CD, a DAT tape, a RAM memory and a semiconductor memory.

14. Apparatus as claimed in claim 11 wherein the means for providing a sound file comprises means for downloading the sound file.

15. Apparatus as claimed in claim 14 wherein the means for downloading the sound file includes one of a personal computer, a personal data assistant (PDA), a telephone, a cellular telephone, and a wireless telephone.

16. Apparatus as claimed in claim 14 wherein the means for downloading the sound file includes a CD writer.

17. Apparatus as claimed in claim 14 wherein the means for downloading the sound file includes an MP3 player.

18. Apparatus as claimed in claim 14 wherein the sound file includes one of the following formats: waveform data (.WAV), audio/visual interleaved data (.AVI), MIDI information (.RMI), multimedia movie (.RMN), a bundle of RIFF files (.BND) and an MP3 file.

19. Apparatus as claimed in claim 14 wherein the audio channel includes at least one of an analog output, an analog input, and a digital input.

20. Apparatus as claimed in claim 19 wherein the audio channel includes a link selected from the following a physical link, a radio frequency (RF) link, an infrared (IR) link, an acoustic link, and an optical link.
